(19) United States
(12) Patent Application Publication
(10) Pub. No.: US 2025/0375329 A1
(43) Pub. Date: Dec. 11, 2025

(54) ARMREST AND WHEELCHAIR ASSEMBLY

(71) Applicant: Sunrise Medical (US) LLC, Fresno, CA (US)

(72) Inventor: Jefferey Bashian, Clovis, CA (US)

(73) Assignee: Sunrise Medical (US) LLC, Fresno, CA (US)

(21) Appl. No.: 19/227,892

(22) Filed: Jun. 4, 2025

Related U.S. Application Data
(60) Provisional application No. 63/656,665, filed on Jun. 6, 2024.

(51) Int. Cl. A61G 5/12; A61G 5/10

(52) U.S. Cl. CPC A61G 5/125; A61G 5/1067; A61G 5/122

(57) ABSTRACT

A wheelchair having an armrest that includes a backrest and armrests mounted on a shear plate of the backrest. The backrest selectively has coordinated counterrotation movement relative to at least one of the armrests. Selective coordinated counterrotation movement may be employed with a wheelchair having powered movement of the backrest and armrests and with a wheelchair having manual movement of the backrest and armrests.

### CROSS-REFERENCE TO RELATED APPLICATIONS

The present application claims the benefit of U.S. provisional patent application 63/656,665, filed Jun. 6, 2024, the contents of which are incorporated herein in their entirety.

### BACKGROUND OF THE INVENTION

Many wheelchairs have backrests that recline and armrests to support a wheelchair user's arms. The backrests may include a shear plate that is fixed relative to the user, which allows the backrest to move when reclining to prevent relative motion between the user and the backrest. The armrests are mounted such that, when a backrest is reclined, the armrest tips up so that the armrest is no longer in a generally horizontal position to support the user's arms.

### SUMMARY OF THE INVENTION

According to an embodiment, a wheelchair has armrest rotation that is coordinated with backrest recline rotation. This allows for reclining of the backrest for a user, with a shear plate that allows the backrest to move with the user, while also maintaining the armrest in a generally horizontal orientation (coordinated counterrotation movement (mode)).

According to an embodiment, the armrests are mounted to the shear plate to allow for the selective coordinated counterrotation movement (mode) of the backrest and armrests.

According to an embodiment, for a powered armrest, a static distance between a user's back-shoulders and the armrests is maintained during the coordinated counterrotation movement (mode) of the backrest and the armrests.

According to an embodiment, electronic controls in a powered armrest control the coordination of counterrotation movement (mode) of the armrests and backrests.

According to an embodiment, a manual armrest allows for coordination of the backrest and armrest counterrotation movement (mode) via a cam or linkage mechanism.

According to an embodiment, each armrest rotates about a generally vertical axis to move out of the way for transfer of a user into and out of the wheelchair, all while allowing for the coordinated backrest and armrest counterrotation movement (mode).

According to an embodiment, the armrests can be flipped-up adjacent to the backrest without colliding with the backrest.

According to an embodiment, each armrest rotates about a second generally vertical axis to allow for width adjustment between the two armrests.

According to an embodiment, armrest pads are translatable fore and aft (longitudinally) relative to the armrest support arms.

According to an embodiment, armrest lateral axes about which the armrests pivot are adjacent to respective locations where a user's elbows rest on the armrest pads. This allows for a distance between an armrest pad and a user's elbow to not change during backrest recline.

According to an embodiment, for a powered armrest, powered backrest height adjustment and powered armrest adjustment are provided for a wheelchair having the coordinated counterrotation movement (mode) of the armrests and backrest.

According to an embodiment, a wheelchair comprises a backrest and armrests where the backrest has selective coordinated counterrotation movement (mode) relative to one or both armrests.

According to an embodiment, a method of operating a wheelchair comprises a backrest selectively coordinating counterrotation movement (mode) relative to one or both armrests.

In accordance with an embodiment, a wheelchair comprises a seat frame; a backrest frame including a backrest support mounted to and pivotally engaged with the seat frame, and a shear plate mounted to the backrest support and configured to be selectively slidable relative to the backrest support; and an armrest assembly mounted on and moveable with the shear plate relative to the backrest support.

In accordance with an embodiment a method of operating a wheelchair comprises the steps of pivoting a backrest frame relative to a seat frame in a first direction about a laterally extending backrest axis; and automatically pivoting an armrest pad of an armrest assembly in a second opposite direction about a laterally extending armrest axis as the backrest frame is pivoted in the first direction about the laterally extending backrest axis, causing a coordinated counter rotation movement, wherein the armrest pad is configured for a user of the wheelchair to rest an arm on.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic, perspective view of a portion of a wheelchair frame.

FIG. 2 is a schematic, perspective view of a portion of a wheelchair frame.

FIG. 3 is a schematic, perspective view of a portion of a wheelchair frame similar to FIG. 1, but with a backrest in a more upright position and an armrest tilted more downward.

FIG. 4 is a schematic, perspective view of a portion of a wheelchair frame. Looking downward.

FIG. 5 is a schematic, perspective view of a portion of an armrest.

FIG. 6 is a schematic, perspective view of a portion of the armrest in an upward tilted position, with an outer covering removed to show a powered armrest mechanism.

FIG. 7 is a schematic view similar to FIG. 6, but with the armrest shown in a downward tilted position.

FIG. 8 is a schematic view of a portion of a power actuation system of the wheelchair of FIGS. 1-7.

FIG. 9 is a schematic, perspective view of a portion of a wheelchair frame according to a second embodiment.

FIG. 10 is a schematic, perspective view of a portion of a wheelchair frame according to the second embodiment.

FIG. 11 is a schematic, perspective view of a portion of a wheelchair frame according to the second embodiment.

FIG. 12 is a schematic, perspective view of a portion of a wheelchair frame according to the second embodiment.

FIG. 13 is a schematic, perspective view of a portion of a wheelchair frame according to the second embodiment.

FIG. 14 is a schematic, perspective view of a portion of a wheelchair frame according to the second embodiment.

FIG. 15 is a schematic, perspective view of a portion of a wheelchair frame according to the second embodiment, with the backrest in a recline position.

### DETAILED DESCRIPTION OF THE PREFERRED EMBODIMENT

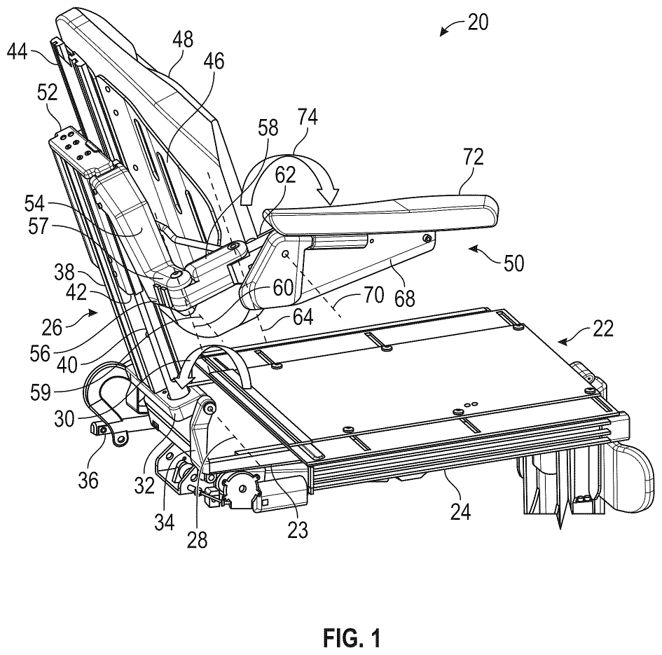

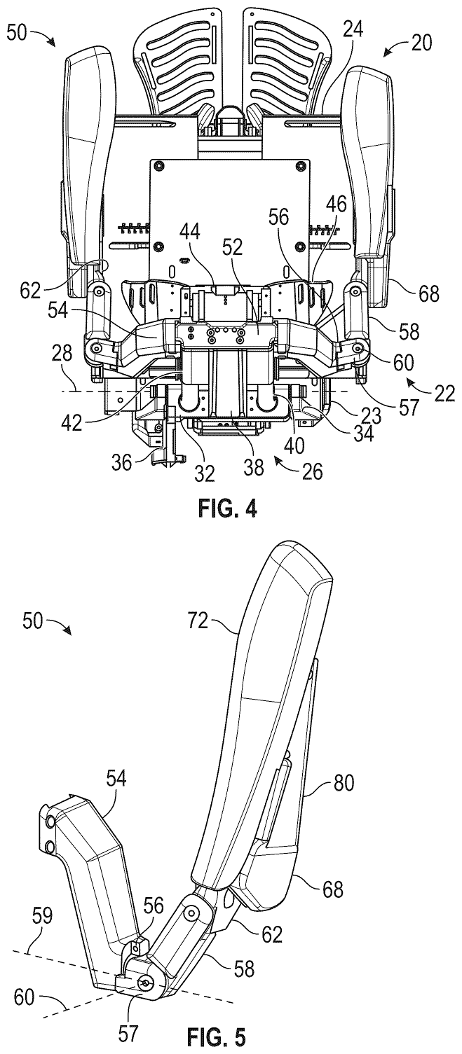

FIGS. 1-8 illustrate an example of a first embodiment of a wheelchair 20 having a wheelchair frame 22. The wheelchair frame 22 includes a seat frame 23, which includes a seat pan 24, upon which a wheelchair user sits, and a backrest frame 26, which supports a back of the user. The backrest frame 26 is rotatable relative to the seat frame 23 about a horizontal backrest axis 28, the relative rotation illustrated by arrow 30 in FIG. 1. Horizontal, as used herein, is relative to the wheelchair 20 when resting on a horizontal surface.

The backrest frame 26 includes a laterally extending base 32 that connects between a pair of support members 34, which in turn mount to the seat frame 23. The structural aspects of the wheelchair structure are generally symmetrical on the right and left sides of the wheelchair 20; thus, where only one side is illustrated in the figures, the other side (left-right) is generally a mirror image. The term lateral, as used herein, is a side-to-side direction of the wheelchair 30. The base 32 is rotatable about the horizontal backrest axis 28 relative to the seat frame 23. A powered backrest rotation mechanism 36 is actuatable to cause the rotation of the backrest frame 26 about the horizontal backrest axis 28. The powered backrest rotation mechanism 36 may be powered by a power supply 37 electrically, pneumatically or hydraulically, and controlled by a controller 39 that may operatively engage a human-machine interface (e.g., a joystick) 41 of a power actuation system 35.

Mounted to and extending upward from the base 32 is a backrest support 38 and a pair of vertical backrest control rods 40. A shear plate 42 mounts to the vertical backrest control rods 40 and is selectively slidable up and down the backrest control rods 40. The shear plate 42 and the backrest support 38 are operatively coupled such that a powered control of the shear plate 42 relative to the backrest support 38 selectively controls the height of the shear plate 42 relative to the backrest support 38. A backrest plate 44, which supports a backrest shell 46, is mounted on the shear plate 42. A backrest pad 48, which supports a user's back, is mounted on the backrest shell 46. Thus, as the shear plate 42 is raised and lowered relative to the base 32, the backrest shell 46 and backrest pad 48 are raised and lowered relative to the seat frame 23. A lateral cross brace 52 is mounted on top of the backrest support 38 and acts as a stop for the maximum height of the shear plate 42 above the seat frame 24.

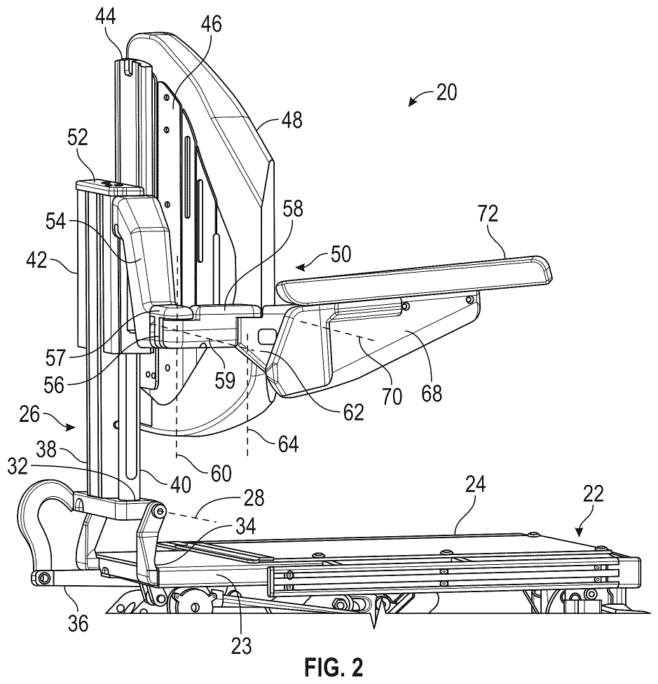

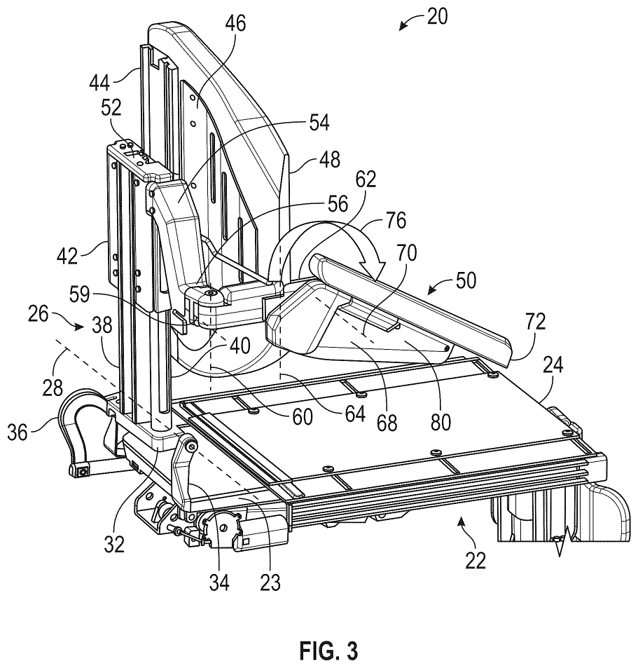

An armrest assembly 50 includes a pair of laterally extending armrest supports 54, each mounted on a opposite lateral side of the shear plate 42. The laterally extending armrest supports 54 move up and down with the shear plate 42. This configuration may allow for a static distance between a user's back/shoulders and the armrest assemblies 50. This configuration may also allow for powered backrest height-armrest height adjustment. A laterally outer end 56 of each of the laterally extending armrest supports 54 is rotationally connected adjacent to a respective armrest flip-back member 57, which rotates about a generally horizontal flip-back axis 59. Each of the armrest flip-back members 57 is rotationally connected adjacent to a rear end of a respective first forward extending support arm 58. Each of the first forward extending support arms 58 is selectively rotatable relative to its respective lateral armrest support 54 about a respective rear armrest vertical axis 60. While the rear armrest vertical axes 60 may extend essentially directly vertical when the backrest frame 26 is in a full upright vertical position (as shown in FIGS. 2 and 3), the rear armrest vertical axes 60 may extend somewhat off from directly vertical when the backrest frame 26 is reclined (see FIG. 1). Also, while the armrest flip-back members 57 are shown in the FIGS. 1-3 in a use position for a wheelchair user, the armrest flip-back members 57 may selectively rotate about their respective flip-back axes 59 so that they extend in a generally vertical orientation (illustrated in FIG. 5), as may be employed when transferring a user laterally into and out of the wheelchair 20. A forward end of respective ones of the first forward extending support arms 58 is rotationally connected adjacent to a rear end of respective ones of a pair of a second forward extending support arm 62. Each of the second forward extending support arms 62 are selectively rotatable relative to its respective first forward extending support arm 58 about a respective forward armrest vertical axis 64. As with the rear armrest vertical axes 60, the verticality of the forward armrest vertical axes 64 varies based on the recline angle of the backrest frame 26. The rotation of members about the rear armrest vertical axes 60 and the forward armrest vertical axes 64 may be employed to selectively vary a gap between the two armrests of the armrest assembly 50. With this arrangement of components, the armrest assemblies 50 may be flipped back about the flip-back axes 59 without colliding with the backrest pad 48.

The armrest assembly 50 also includes a pair of armrest support arms 68, which are each rotationally connected adjacent to a respective forward end of the second forward extending support arms 62. Each of the armrest support arms 68 selectively rotates relative to the respective second forward extending support arm 62 about a respective armrest lateral axis 70. Selective rotation of the respective armrest support arms 68 about the respective lateral axes 70 changes the angle of the respective armrest support arms 68 relative to backrest shell 46. Each of the armrest support arms 68 has a respective armrest pad 72 slidably mounted thereon. The armrest pads 72 are each respectively slidable longitudinally relative to its respective armrest support arm 68.

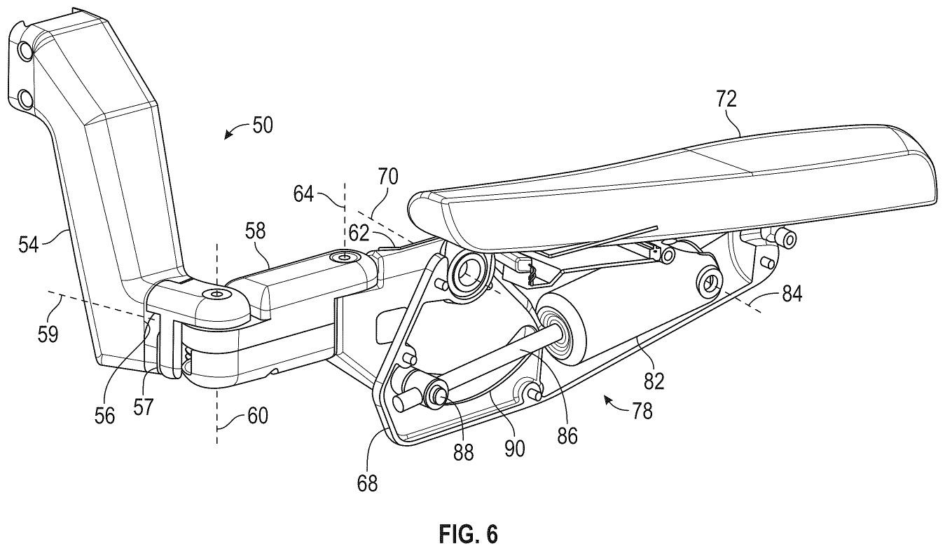

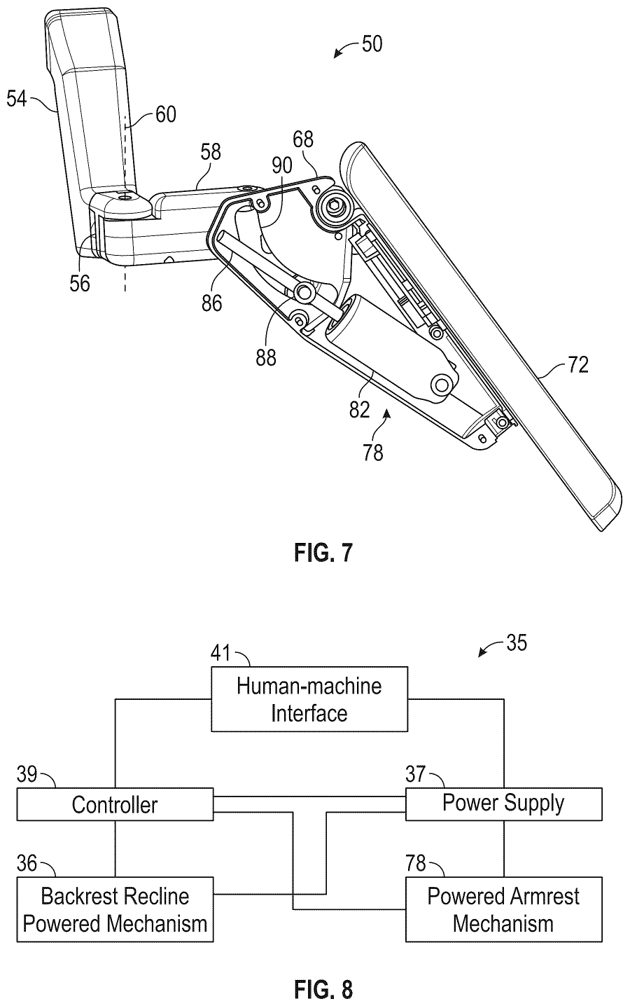

Powered armrest mechanisms 78 of the armrest assemblies 50 (best seen in FIGS. 6 and 7, where an armrest outer covering 80 is not shown) are each mounted to the respective armrest support arm 68. The armrest coverings 80 are shown in FIGS. 1-5. Each powered armrest mechanism 78 includes a motor-gearbox assembly 82, which is pivotally connected to the armrest support arm 68 about a pivot axis 84 and includes a threaded shaft 86 extending from and rotationally driven by the motor-gearbox assembly 82. Each of the threaded shafts 86 is also threaded to a respective sliding nut 88, which are each captured in a respective curved slot 90 in the respective armrest support arm 68. Wires from the power actuation system 35 may be routed through the components of the armrest assemblies 50 (e.g., through the lateral armrest supports 54, the armrest flip-back member 57, the first forward extending support arms 58, and the second forward extending support arms 62) to protect the wires from potential damage. When the motor-gearbox assembly 82 is activated, it causes the corresponding threaded shaft 86 to rotate. Rotation in a first direction causes the corresponding sliding nut 88 to be pushed along the corresponding threaded shaft 86 away from the corresponding motor-gearbox assembly 82, thus sliding the corresponding sliding nut 88 toward a rear end of the corresponding curved slot 90 (as illustrated in FIG. 6). This motion rotates the armrest pad 72 into an upward tilted armrest position (as illustrated in FIGS. 2 and 6). Rotation in a second, opposite direction causes the corresponding sliding nut 88 to be pulled along the corresponding threaded shaft 86 toward the corresponding motor-gearbox assembly 82, thus sliding the corresponding sliding nut 88 toward a forward end of the corresponding curved slot 90 (as illustrated in FIG. 7). This motion rotates the armrest pad 72 into a downward tilted armrest position (as illustrated in FIGS. 1, 3 and 7). The same actuations apply to the opposite armrest assembly 50 for upward and downward tilt. For each of the armrest assemblies 50, the configuration of the powered armrest mechanism 78 causes the location of the armrest lateral axis 70 to be adjacent to where a user's elbow would rest on the armrest pad 72, which may reduce movement of the human-machine interface 41 (when mounted on the armrest assembly 50) relative to a user's hand when tilting the armrest assembly 50.

The operation of the example of a wheelchair 20 illustrated in FIGS. 1-8 will now be discussed. A wheelchair user may occupy the wheelchair 20, with the backrest frame 26 (and thus backrest shell 46) in an upright (e.g., essentially vertical) position (as illustrated in FIGS. 2-3). In this upright position, the armrest assembly 50 may be oriented so that the armrest pad 72 is in a generally horizontal position (as illustrated in FIGS. 2 and 6). The user may wish to recline the backrest shell 46 while keeping the armrest pads 72 horizontal for comfort. The wheelchair 20 may be selectively set to a coordinated counterrotation mode (coordinated counterrotation movement), which may be accomplished by using the human-machine interface 41 to instruct the controller 39 to activate such a mode. The user may then use the human-machine interface 41 to instruct the controller 39 to activate the powered mechanism 36, which may be supplied with power from the power supply 37, to cause the backrest frame 26 to begin reclining (rotating about the horizontal backrest axis 28) in the direction indicated by arrow 30 (illustrated in FIG. 1), with the controller 39 activating the motor-gearbox assembly 82 to cause the powered armrest mechanism 78 to simultaneously rotate the armrest support arms 68 in an opposite direction (counterrotation), as indicated by arrow 74 in FIG. 1, maintaining the armrest pads 72 in a generally horizontal position as the backrest frame 26 reclines. This coordinated counterrotation movement thus allows the user to recline the backrest shell 46 (and thus the backrest pad 48) while maintaining the armrest pads 72 in a generally horizontal position throughout the relining operation. The coordinated counterrotation mode (movement) may also be actuated in the opposite rotational direction, bringing the backrest frame 26 back to the generally upright position while maintaining armrest pads 72 in a generally horizontal position throughout the raising operation. While the above-discussed operation discloses maintaining a generally horizontal armrest position, the controller 39 can be programmed to maintain a different angle or a different amount of tilting relative to the amount of backrest tilting, if so desired.

With the controller 39 set in a non-coordinated counterrotation mode, the user may rotate one or both armrest support arms 68 (i.e., independent right/left armrest positions) without a change in recline position of the backrest frame 26 (see arrow 76 in FIG. 3). In both modes, the height of the backrest shell 46 and armrest assemblies 50 may be adjusted up or down relative to the seat frame 24 by sliding the shear plate 42 relative to the backrest support 38. The height of the backrest shell 46 may be adjusted up or down relative to the seat frame 24 during recline operations in order to keep the backrest pad 48 at a same location on the user's back during recline operations. This configuration also allows for maintaining a static distance between the user's back/shoulders and the armrest assemblies 50 during recline and back-to-upright position operations.

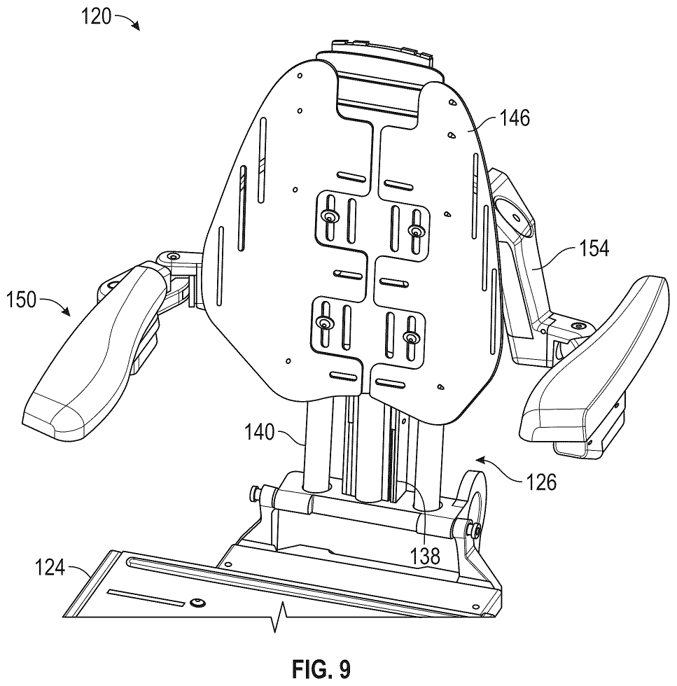

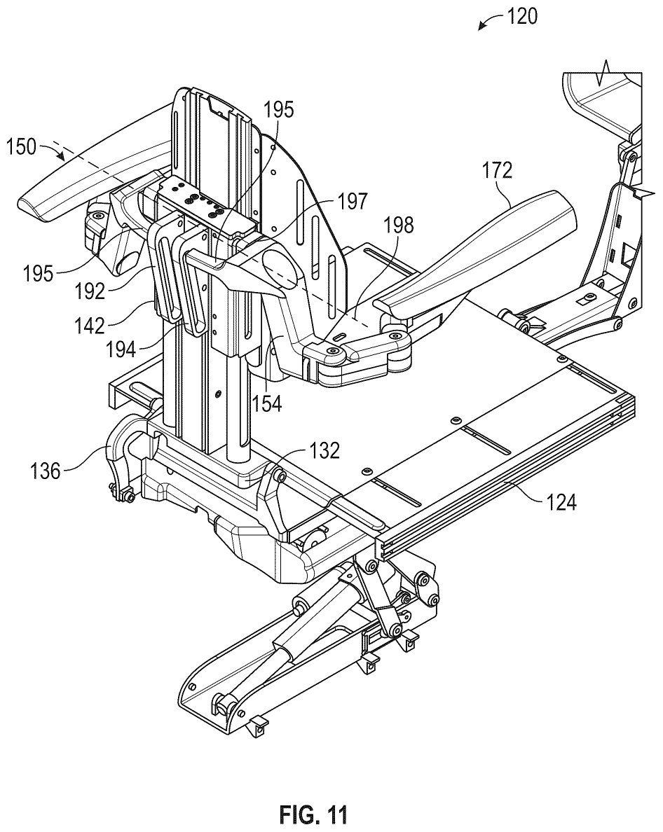

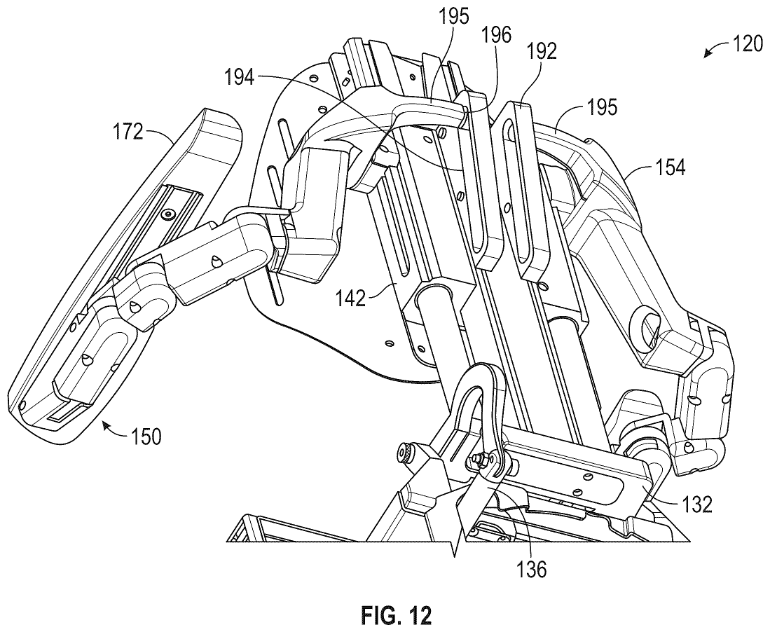

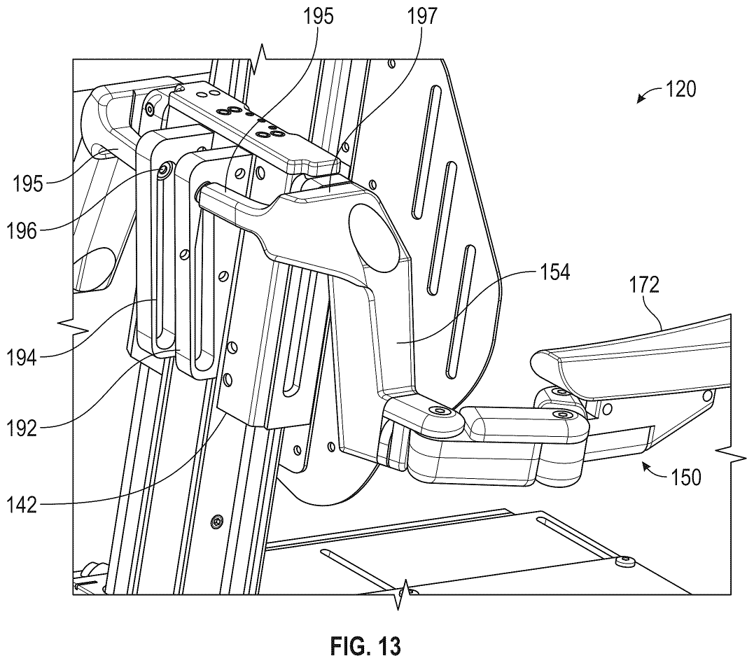

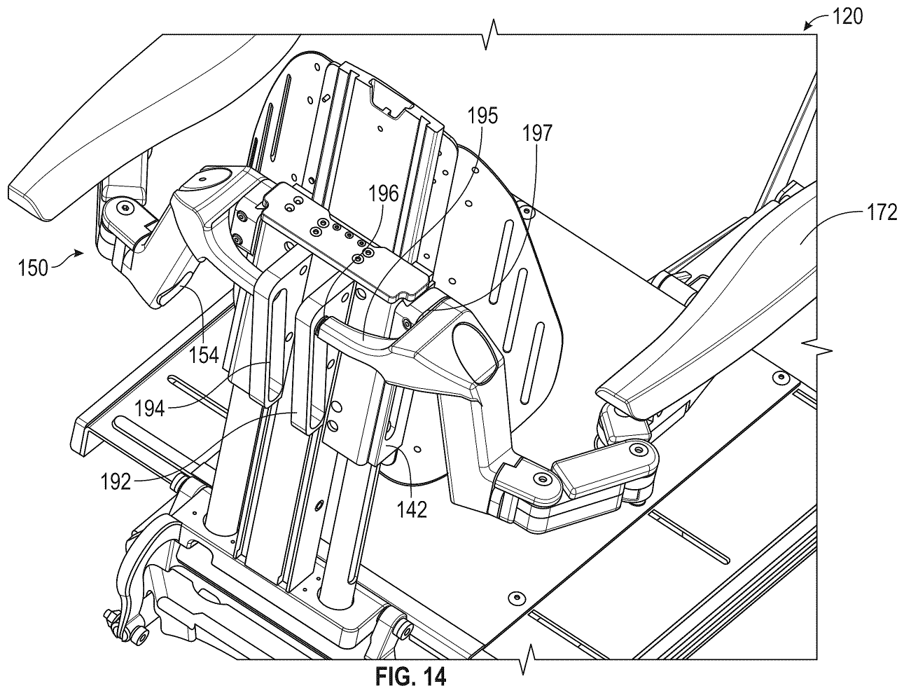

FIGS. 9-15 illustrate an example of a second embodiment of a wheelchair 120. The wheelchair 120 in the second embodiment is similar to the first embodiment with an exception that the rotation of the armrest assembly 150 is manual rather than powered. Thus, to avoid unnecessary repetition, the elements that are generally similar to the first embodiment (e.g., backrest frame, seat frame, first forward extending support arm, second forward extending support arm, and armrest flip-back member) will not be discussed again relative to this second embodiment. Elements discussed relative to the second embodiment and illustrated in the second embodiment will have the same numbers as corresponding elements in the first embodiment but using 100-series numbers.

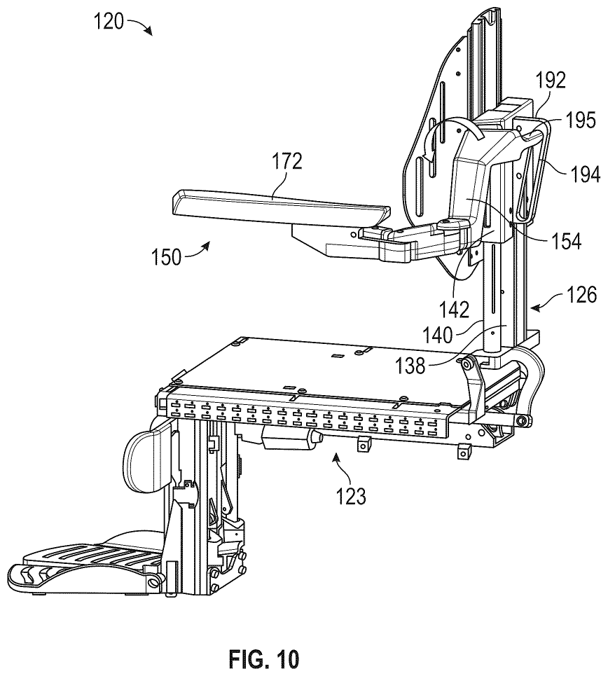

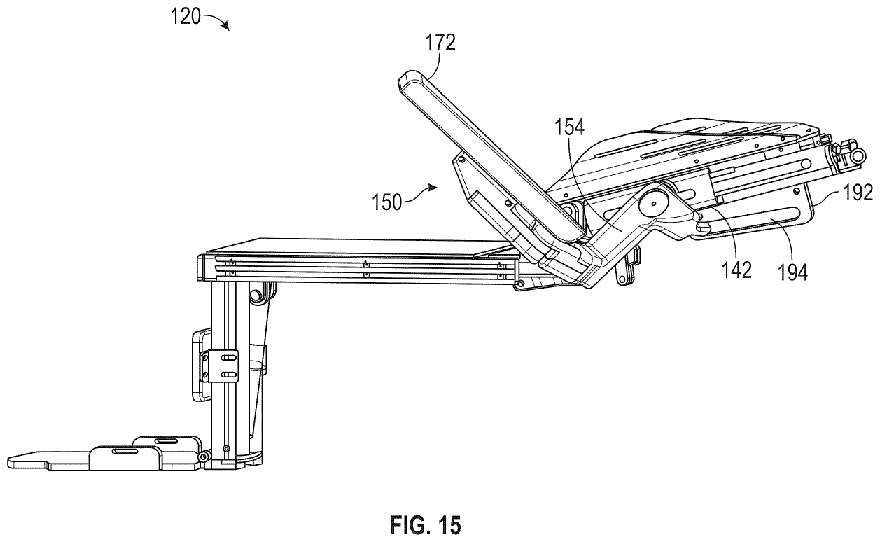

The armrest assembly 150 includes the lateral armrest supports 154 that mount to and linearly slide with the shear plate 142. A pair of cam brackets 192 are mounted to the backrest support 138. The cam brackets 192 are fixed relative to the backrest support 138, thus, when the shear plate 142 is moved up and down relative to the backrest support 138, the shear plate 142 slides relative to the cam brackets 192 as well. Each cam bracket 192 includes a cam slot 194, which is farther away from the backrest support 138 at its upper end than at its lower end. A pair of cam arms 195 are pivotally connected to the lateral armrest supports 154 and each extends laterally inward, with respective cam followers 196 at the laterally inner ends. Each of the cam followers 196 is slidably mounted in a respective one of the cam slots 194. The cam followers 196 are located adjacent to the upper end of the cam slots 194 when the backrest frame 126 is in an upright position (as illustrated in FIGS. 10-14). The cam followers 196 slide down in the cam slots 194 as the backrest frame 126 is reclined, with the cam followers 196 being located adjacent to the lower ends of the cam slots 194 when the backrest is fully reclined (as illustrated in FIG. 15). The lateral armrest supports 154 each includes a pivot location 197, which defines a generally horizontal lateral axis 198 about which the armrest assemblies 150 can pivot. As the backrest is reclined, the cam followers 196 slide down in their respective cam slots 194, causing the armrest assemblies 150 to pivot relative to the backrest assembly in a counterrotation direction (i.e., coordinated counterrotation movement (mode). This allows the armrest pads 172 to remain generally more horizontal as the backrest frame 126 is reclined.

Depending upon the angle and location of the slots 194, as the backrest assembly 126 is reclined, the armrest pads 172 pivot in an opposite direction (coordinated counter rotation movement) but may not remain in an essentially horizontal position at or near full recline (see FIG. 15). The armrest rotation still provides counterrotation to the seatback but may not completely remain horizontal.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A wheelchair comprising:
a seat frame;
a backrest frame including a backrest support mounted to and pivotally engaged with the seat frame, and a shear plate mounted to the backrest support and configured to be selectively slidable relative to the backrest support; and
an armrest assembly mounted on and moveable with the shear plate relative to the backrest support.

2. The wheelchair of claim 1 wherein the armrest includes an armrest pad configured for a user of the wheelchair to rest an arm on and the armrest assembly is configured to cause the armrest pad to pivot about an armrest lateral axis in an opposite direction of a pivoting of the backrest frame relative to the seat frame about a lateral backrest axis in a coordinated counterrotation movement.

3. The wheelchair of claim 2 further including a cam bracket mounted on the backrest support, with the shear plate slidable relative to the cam bracket, the cam bracket including a cam slot that has a first upper end that is farther away from the backrest support than an opposed second lower end, and wherein the armrest assembly includes a cam follower configured to be slidable within the cam slot such that a pivoting of the backrest frame about the lateral backrest axis in a first direction causes the cam follower to slide in the cam slot thereby causing the armrest assembly to pivot about the armrest lateral axis in a second opposite direction.

4. The wheelchair of claim 2 further comprising a powered actuation system that includes a powered backrest recline mechanism configured to selectively pivot the backrest frame relative to the seat frame, and a powered armrest mechanism configured to selectively pivot the armrest pad relative to the backrest support, and a controller configured to selectively operate in a coordinated counterrotation mode wherein when the controller activates the powered backrest recline mechanism to cause the backrest frame to pivot about a lateral backrest axis in a first direction, the controller activates the powered armrest mechanism to cause the armrest pad to pivot about the armrest lateral axis in a second opposite direction.

5. The wheelchair of claim 4 wherein the controller, when operating in the coordinated counterrotation mode, is configured to maintain the armrest pad at a constant angle relative to the seat frame as the powered backrest recline mechanism pivots the backrest frame.

6. The wheelchair of claim 4 wherein the controller includes a non-coordinated counterrotation mode configured to actuate the powered armrest mechanism to selectively pivot the armrest pad relative to the backrest support while the powered backrest recline mechanism is not pivoting the backrest frame.

7. The wheelchair of claim 2 wherein the armrest lateral axis about which the armrest pad pivots is configured to be located adjacent to an elbow of the user when the arm of the user is resting on the armrest pad.

8. The wheelchair of claim 7 wherein the armrest assembly includes an armrest support arm configured to support the armrest pad and pivot about the armrest lateral axis, a motor-gearbox assembly mounted to and pivotal relative to the armrest support arm about a lateral pivot axis, and a controller configured to actuate the motor-gearbox assembly to cause the armrest pad to pivot relative to the backrest frame.

9. The wheelchair of claim 8 wherein the armrest support arm includes a curved slot, and the armrest assembly further includes a threaded shaft extending from and rotationally drivable by the motor-gearbox assembly, and a sliding nut threadably received on the threaded shaft and slidably captured in the curved slot such that rotation of the threaded shaft causes the sliding nut to slide along the curved slot.

10. The wheelchair of claim 2 wherein the armrest assembly includes an armrest support arm configured to support the armrest pad and pivot about the armrest lateral axis, a motor-gearbox assembly mounted to and pivotal relative to the armrest support arm about a lateral pivot axis, and a controller configured to actuate the motor-gearbox assembly to cause the armrest pad to pivot relative to the backrest frame.

11. The wheelchair of claim 10 wherein the armrest support arm includes a curved slot, and the armrest assembly further includes a threaded shaft extending from and rotationally drivable by the motor-gearbox assembly, and a sliding nut threadably received on the threaded shaft and slidably captured in the curved slot such that rotation of the threaded shaft causes the sliding nut to slide along the curved slot.

12. The wheelchair of claim 2 wherein the armrest pad is slidable in a direction toward and away from the backrest frame.

13. The wheelchair of claim 1 wherein the armrest assembly includes a laterally extending armrest support mounted on a laterally inner end to the shear plate, and an armrest flip-back member mounted to and pivotable about a laterally outer end of the laterally extending armrest support for pivoting about a laterally extending flip-back axis, wherein pivoting the flip-back member about the laterally extending flip-back axis pivots an armrest pad between a generally horizontal position where the armrest pad is adjacent to the seat frame and a generally vertical position where the armrest pad is adjacent to the backrest frame.

14. The wheelchair of claim 1 wherein the armrest assembly includes a laterally extending armrest support mounted on a laterally inner end to the shear plate, and a first forward extending support arm configured to be supported by and pivotable relative to the laterally extending armrest support about a rear armrest vertical axis, wherein pivoting of the first forward support arm about the rear armrest vertical axis moves an armrest pad laterally inward and laterally outward relative to the seat frame.

15. The wheelchair of claim 1 wherein the armrest assembly includes a laterally extending armrest support mounted on a laterally inner end to the shear plate, and an armrest flip-back member mounted to and pivotable about a laterally outer end of the laterally extending armrest support for pivoting about a laterally extending flip-back axis, a first forward extending support arm configured to be supported by and pivotable relative to the armrest flip-back member about a rear armrest vertical axis, a second forward extending support arm configured to be supported by and pivotable relative to the first forward extending support about a forward armrest vertical axis, and an armrest pad supported by the second forward extending support arm.

16. A method of operating a wheelchair comprising the steps of:
pivoting a backrest frame relative to a seat frame in a first direction about a laterally extending backrest axis; and
automatically pivoting an armrest pad of an armrest assembly in a second opposite direction about a laterally extending armrest axis as the backrest frame is pivoted in the first direction about the laterally extending backrest axis, causing a coordinated counter rotation movement, wherein the armrest pad is configured for a user of the wheelchair to rest an arm on.

17. The method of claim 16 further comprising:
actuating pivoting of the backrest frame with a powered backrest recline mechanism;
actuating pivoting of the armrest pad with a powered armrest mechanism; and
activating the powered backrest recline mechanism and the powered armrest mechanism with a controller operating in a coordinated counterrotation mode to cause the coordinated counterrotation movement.

18. The method of claim 16 further comprising:
sliding a shear plate along a backrest support of the backrest frame during the coordinated counterrotation movement; and
sliding the armrest assembly with the shear plate.

19. The method of claim 16 further comprising:
sliding a shear plate along a backrest support of the backrest frame during the coordinated counterrotation movement; and
sliding a cam arm of the armrest assembly in angled cam slots that are fixed relative to the backrest support during the coordinated counterrotation movement.

20. The method of claim 16 further comprising:
actuating a motor-gearbox mounted to and pivotable with the armrest pad to cause the armrest pad to pivot about the laterally extending armrest axis, with the laterally extending armrest axis configured to be located adjacent to an elbow of a user when an arm of the user is resting on the armrest pad.
